(19) United States
(12) Patent Application Publication
(10) Pub. No.: US 2018/0335114 A1
(43) Pub. Date: Nov. 22, 2018

(54) PLANETARY SCREW MECHANISM

(71) Applicant: Goodrich Actuation Systems SAS, Buc (FR)

(72) Inventor: Arnaud De La Chevasnerie, Ville d'Avray (FR)

(21) Appl. No.: 15/927,202

(22) Filed: Mar. 21, 2018

(30) Foreign Application Priority Data
May 22, 2017 (EP) 17305594.8

(51) Int. Cl. F16H 25/22

(52) U.S. Cl. CPC F16H 25/2252; F16H 25/2006

(57) ABSTRACT

An improved planetary roller screw mechanism is described comprising a screw having an outer thread; a nut disposed around and positioned coaxially with the screw, and a plurality of rollers that are disposed between the screw and the nut, each of said rollers being provided with an outer thread that engages with an outer thread of the screw and an inner thread of the nut. Each of said plurality of rollers has a thread profile that has at least a convex portion, and either one, or both of, said screw and said nut has/have a thread profile that has at least a portion that is concave. A method for making and assembling the improved planetary roller screw mechanism is also described.

### FOREIGN PRIORITY

This application claims priority to European Patent Application No. 17305594.8 filed May 22, 2017, the entire contents of which is incorporated herein by reference.

### FIELD OF THE INVENTION

This disclosure relates to the field of mechanical actuators, and in particular, roller, or planetary screws.

### BACKGROUND

A planetary roller screw is a mechanical actuator that works as a rotary to linear conversion device. In other words, they are low-friction; precision screw-type actuators that convert rotational motion to linear motion, or vice versa. These mechanical devices are often used as the actuating mechanism in many electromechanical linear actuators in variety of industries such as manufacturing and aerospace.

Electromechanical actuators having a high stall load and a small space envelope often have a planetary roller screw integrated into their design. In the case of fixed wing aircrafts, the place allocated to the motor will become smaller and smaller and the life duration will become increased for higher permanent loads.

### SUMMARY

A planetary roller screw mechanism is described comprising a screw having an outer circumference with an outer thread; a nut disposed around and positioned coaxially with the screw, the nut comprising an inner thread, and a plurality of rollers that are disposed around the outer circumference of the screw, between the screw and the nut, each of said rollers being provided with an outer thread aligned or engaged with the outer thread of the screw and the inner thread of the nut. Each of the plurality of rollers may have at least a section of its thread profile between a trough and peak which is convex. Either, or both, of the screw and nut may also have at least a section of the thread profile between a peak and a trough that is concave.

In any of the examples described herein the roller may be described as having an axis that is parallel to the axis of the screw and parallel to the axis of the nut.

In some examples described herein, the section of the roller thread profile that is convex may be described as having a convex ogive radius. The section of the screw thread profile that is concave may be described as having a concave ogive radius and the section of the nut thread profile that is concave may also be described as having a concave ogive radius.

In some examples described herein, the screw and/or nut concave ogive radii may be twice the size of the roller convex ogive radius.

In some examples, the peaks of the roller thread profile may be truncated, and the troughs may be rounded. In some examples described herein, the troughs of the modified screw and/or nut thread profiles may be pointed into a sharp V shape. In some examples, the peaks of the modified screw and/or nut thread profiles may be truncated.

A method of forming a planetary roller screw mechanism is also described comprising providing a screw having an outer thread; positioning a nut around the screw so that the nut is coaxial with the screw, the nut comprising an inner thread; and positioning a plurality of rollers around the outer circumference of the screw between the screw and the nut, each of said rollers being provided with an outer thread engaged or aligned with the outer thread of the screw and the inner thread of the nut. The method may further comprise modifying the thread profile of either or both of the screw and nut so that there is at least a portion between a peak and an adjacent trough of the screw and/or nut thread profile that is concave.

In some examples described herein, the method may comprise positioning the roller relative to the screw and/or nut so that the convex portion of the roller thread profile interfaces with/is aligned or engages with the convex portion of the screw and/or nut thread profile.

The screw and/or nut may also be described as having a convex ogive radius and in some examples the screw and/or nut concave ogive radii may be twice the size of the roller convex ogive radius.

### BRIEF DESCRIPTION OF THE DRAWINGS

Preferred embodiments will now be described by way of example only, with reference to the accompanying drawings.

FIG. 1 depicts a perspective cut-away view of a planetary roller screw and nut with a section of the nut cut away so that the internal features are shown.

FIG. 2 depicts a perspective exploded view of FIG. 1

FIG. 3 depicts the thread profile of a known planetary roller screw mechanism showing the contact points and interfaces between a typical roller and a screw or nut.

FIG. 4 depicts the thread profile of an improved planetary roller screw mechanism showing the contact points between a roller and a modified screw or nut.

FIG. 5 depicts the thread profile of a roller such as shown in FIGS. 3 and 4 that may be used in the examples described herein.

FIG. 6 depicts the thread profile of an improved and modified screw or nut such as shown in FIG. 4.

FIG. 7 depicts the thread profile of a known screw or nut which has a straight thread profile.

### DETAILED DESCRIPTION

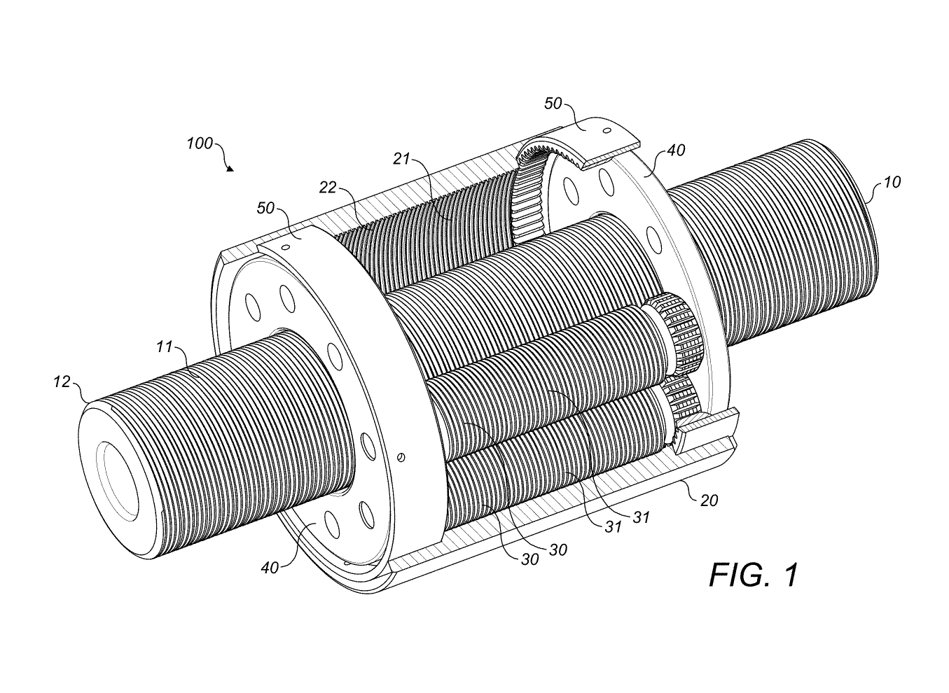

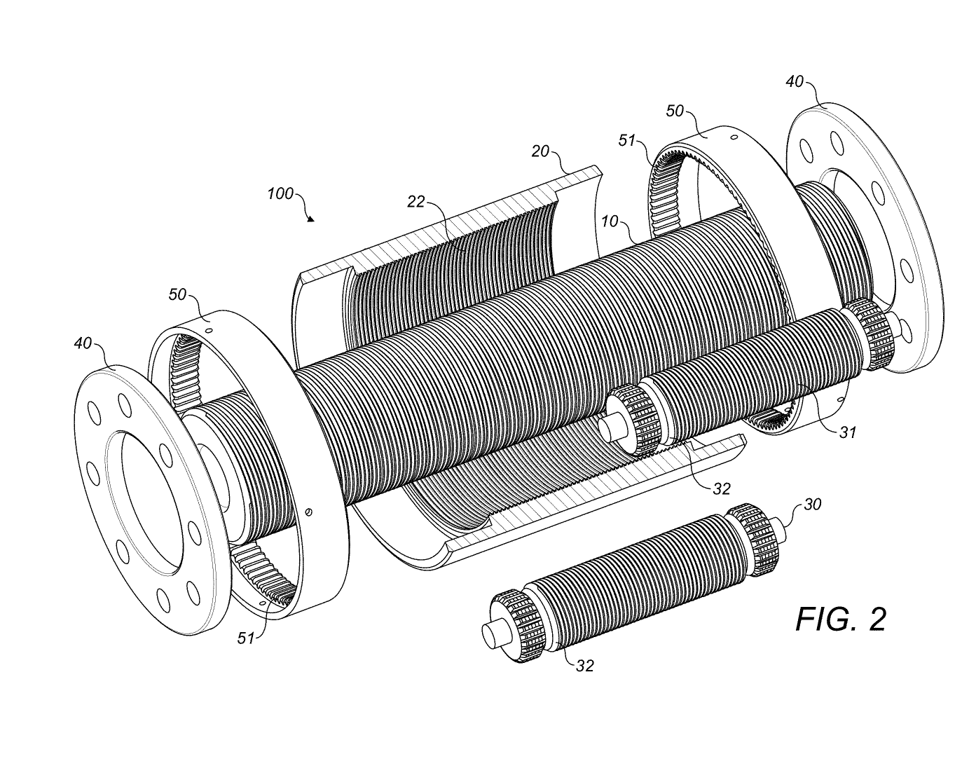

A planetary roller screw mechanism 100 is shown in FIGS. 1 and 2 which show a cut-away perspective view and an exploded perspective view, respectively. The design comprises a screw 10 having an outer circumference 12 on which there is an external screw thread 11. A hollow nut 20 is also provided, which has an internal 22 circumference, on which there is an internal screw thread 21, and a plurality of rollers 30. The screw 10 and nut 20 are concentric. Similar to the screw 10, each of the rollers 30 also has an outer circumference 32, on which there is an external screw thread 31. The rollers 20 are positioned around the outer circumference 12 of the screw 10 so that they lie between the nut 20 and the screw 10 and are in contact with the internal screw thread 21 of the nut 20 and the external screw thread 11 of the screw 10. The rollers 30 are guided by roller guide rings 40, which are provided so as to keep them equally spaced around the outer circumference 12 of the screw 10.

The screw threads 11, 21, 31 of the screw 10, nut 20 and rollers 30 may therefore be described as comprising a helical structure 11, 21, 31 that is provided on the external circumferential surfaces 12, 32 of the screw 10 and rollers 30 and the inner circumferential surface 22 of the nut 20. In greater detail, the screw threads 11, 31 of the screw 10 and rollers 30 are male screw threads 11, 31 that comprise a helical ridge that is wrapped around the outer circumference 13, 33 of the cylindrical body of the screw 10 and rollers 30, whereas the nut 20 has a female screw thread 21 comprising a helical ridge 21 that is wrapped around the inner circumference 23 of the hollow nut 20.

The rotation of the rollers 30 with the nut 20 is controlled by gears 50, as is known in the art. During rotation of a standard planetary roller screw, there is no displacement between the rollers and the nut and the synchronizing gears prevent any sliding of these features relative to each other. Such sliding is disadvantageous as it would block the planetary roller screws if it occurred. For an inverted planetary roller screw, there is no displacement between the rollers and the screw and the synchronizing gears avoid the sliding between those features which would also block the planetary roller screws if it occurred.

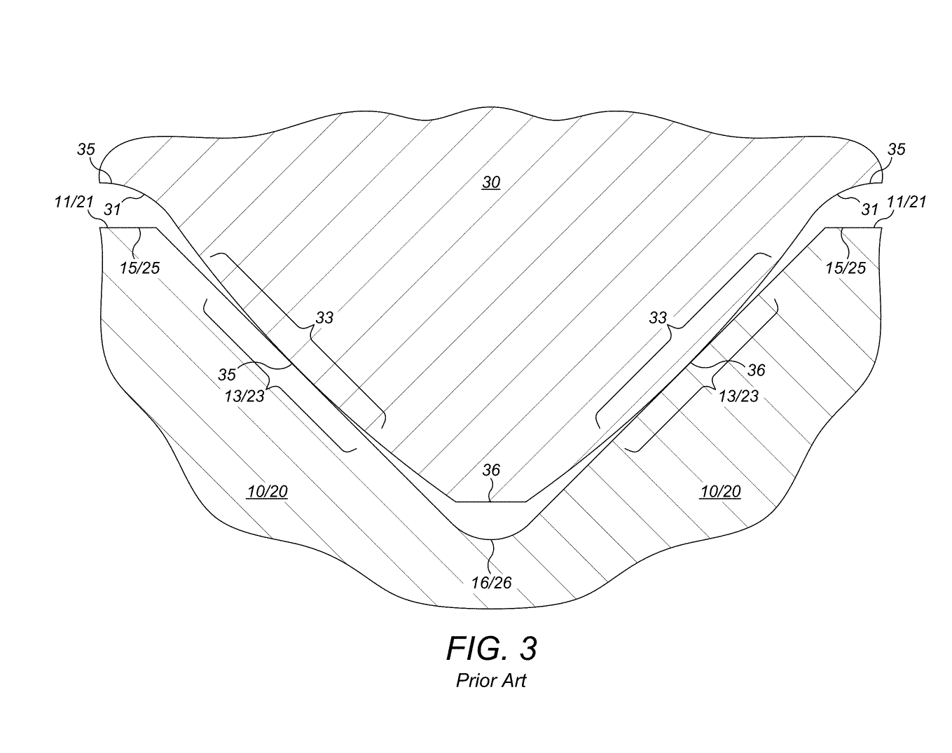

The cross-sectional shape (or thread profiles) of screw threads, 11, 21, 31, 11′, 21′ are depicted in FIGS. 3 to 7. As can be seen in these figures, these screw threads have triangular or V-shaped thread profiles.

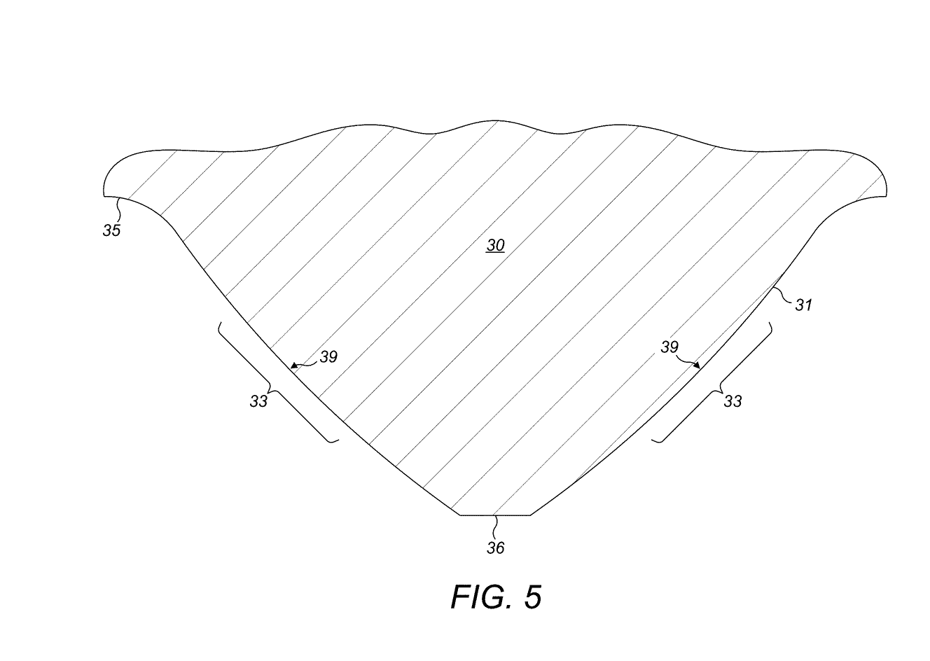

In known roller screws, such as is shown in FIG. 3, the roller 30 comprises a V-shaped thread profile, each V-shaped ridge 31 having a peak 36 between two troughs 35 (or, written another way, a trough 35 between two peaks 36). The thread profile of the section 33 of the screw thread 31 between a trough 35 and an adjacent peak 36, however, is normally convex in shape, as is shown in FIGS. 3 and 5.

The screw 10 and nut 20, also both comprise a V-shaped thread profile, as is shown in FIG. 3, with a V-shaped ridge that extends from a first peak 15, 25 to a trough 16, 26 and to an adjacent second peak 15, 25 (or, written another way, each ridge has a peak 15, 25 between two adjacent troughs 16, 26). Since the profile would be the same between the roller 30 and the screw 10 and the roller 30 and the nut 20, the reference numerals for both the screw 10 and nut 20 are depicted as alternatives in FIG. 3.

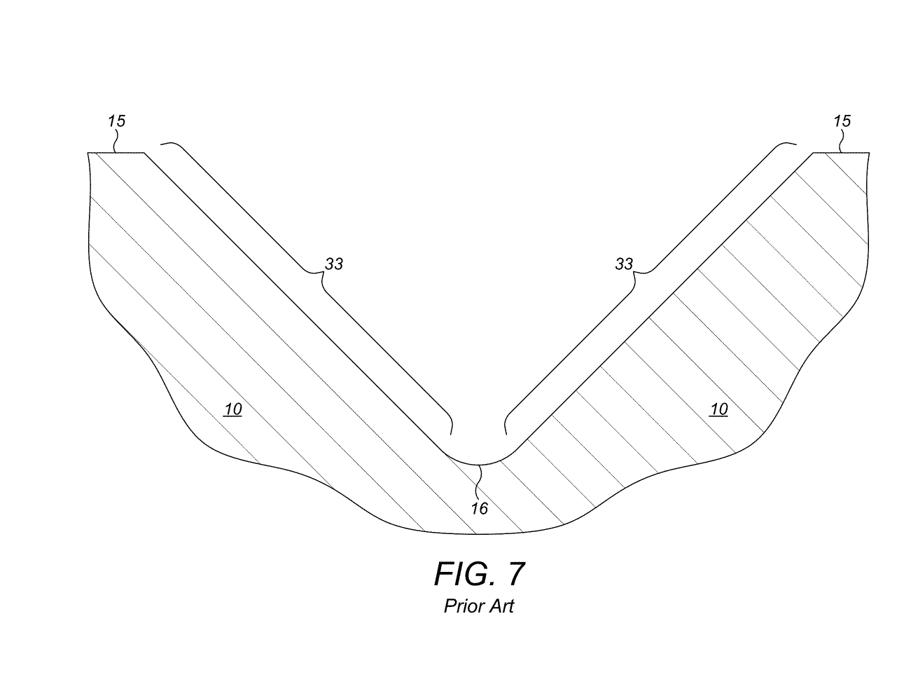

In known planetary screws, such as that shown in FIGS. 3 and 7, the thread profile of the section 13, 23 of the screw thread 11, 21 between a peak 15, 25 and an adjacent trough 16, 26 is straight, as is depicted in FIGS. 3 and 7.

In use, the external screw thread 31 of the rollers 30 has areas or points of contact, 35, 36 at which it interfaces with the internal thread 21 of the nut 20 and the external thread 11 of the screw, as is shown in FIG. 3. In known systems, the portion 33 of the thread profile of the rollers 30 that is convex contacts (at points 35 and 36) and interfaces with the straight section 15, 25 of the screw 10 and/or nut 20 profile, as is shown in FIG. 3.

The improved examples described herein below aim to reduce the Hertz contact stresses at these contact interfaces 35, 36 between the roller 30 and screw 10 and roller 30 and/or roller 30 and nut 20. This is achieved by modifying the thread profiles of the screw 10 and nut 20 and therefore also affecting the contact points 35, 36 between the roller/screw and roller/nut as is described in detail below.

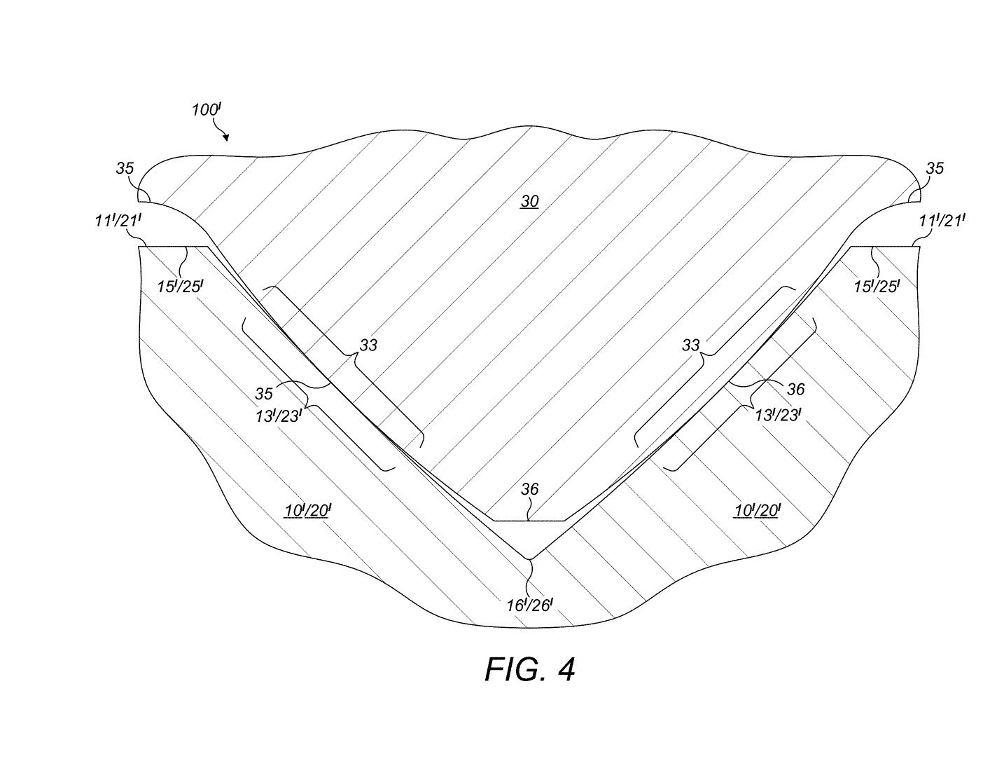

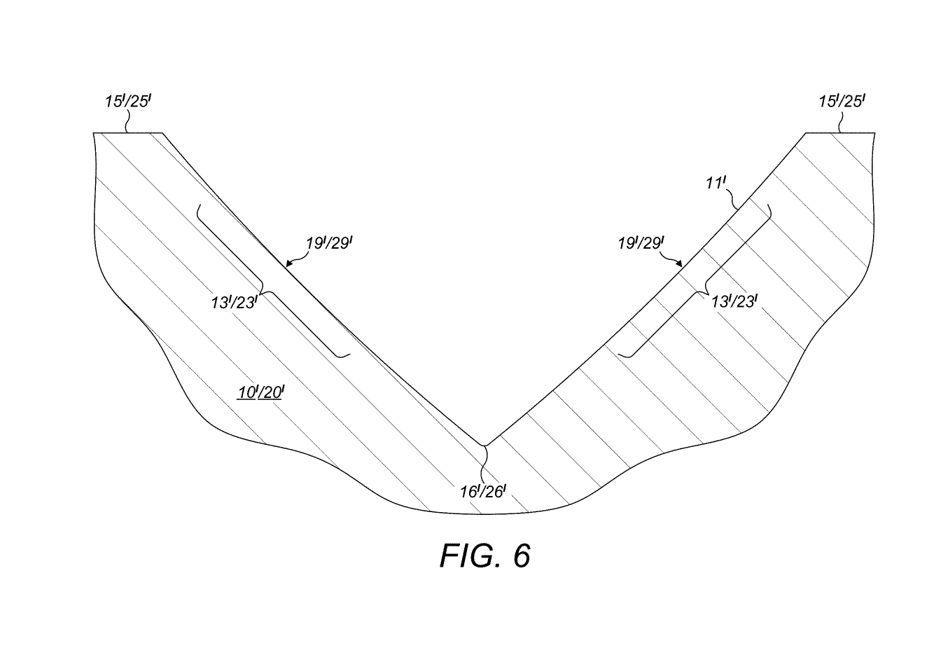

The improved and modified screw and nut are now described. The same reference numerals are used to describe and depict the same features as described with reference to FIGS. 1 to 3, however, the modified and improved features are denoted further by the sign ′ (e.g. 10 when modified is denoted by 10′ etc.). Since the profile would be the same between the roller 30 and the modified screw 10′ and the roller 30 and the modified nut 20′, the reference numerals for both the screw 10′ and nut 20′ are depicted as alternatives in FIGS. 4 and 6.

In the improved examples of the planetary roller screws described herein, as shown in FIGS. 4 to 6, the roller 30 may have the same V-shaped profile as is described above with reference to FIG. 3. In contrast to known mechanisms, however, either one, or preferably both of, the screw threads 11′, 21′, of the screw 10′ and nut 20′ are modified, as depicted in FIGS. 4 and 6, so that, instead of having a section that is straight extending from a peak 15′, 25′, to a trough, 16′, 26′, at least a portion, 13′, 23′ of the screw thread 10′ and/or nut thread 20′ extending from a peak 15′, 25′, to a trough 16′, 26′ has a concave shape. This is depicted most clearly in FIG. 6, which also shows the concave thread radius 19′, 29′.

Therefore, in use, and as shown in FIG. 4, the portion 33 of the rollers 30 that is convex contacts and interfaces at least at a point 35′, 36′ within the portion 13′ of the nut 20′ and/or screw 10′ that is concave, as is shown in FIG. 4.

As can also be seen in FIG. 4, the peaks 15′, 16′, 25′, 26′ of the screw 10′ and/or nut 20′ thread profiles may be truncated. The peaks 36 of the roller thread profiles may also be truncated.

On the other hand, the troughs 16′, 26′ of the modified screw and/or nut 20′ thread profiles may have a sharp V shape extending into the trough 16′, 26′. This is also different to known screw 10 and nut 20 thread profiles as shown in FIG. 3, wherein the trough is rounded.

The modification of the screw and nut thread profiles may be achieved via any suitable method known in the art, such as grinding. Modifying the profiles by grinding is a very accurate method. In FIGS. 4 and 6 the thread profiles and contact points 35′, 36′ between the roller 30 and screw 10′ or nut 20′ is shown.

A method of forming the improved planetary roller screw mechanism 100′ may therefore comprise providing a screw 10′ having an outer circumference with an outer thread 11′ that has a V-shaped thread profile that has at least a portion 13′ extending between a first peak 15′ and a first trough 16′ that is concave, as shown in FIGS. 4 and 6. The method may further comprise providing a nut 20′ that has a modified inner thread 21′ which also has a V-shaped thread profile wherein at least a portion 23′ extending from a peak 25′ to a trough 26′ is concave. In some methods, either or both of the screw 10′ and nut 20′ thread profile may be modified in this way. The method further comprises providing a plurality of rollers 30 that have a thread profile wherein at least a portion 33 extending between a first trough 35 and an adjacent peak 36 is convex, as shown in FIG. 5.

In order to assemble the planetary roller screw mechanism, the nut 20′ can therefore be positioned as shown in FIGS. 1 and 2 so that it is situated around the screw 10′ with the nut 20′ being coaxial with the screw 10′, and further comprising the plurality of rollers 30 around the outer circumference of the screw 10′, between the screw 10′ and the nut 20′. The outer thread 31 of each of the rollers 30 is aligned and/or engaged at least at the convex portion 33 with the corresponding concave portions 13′, 23′ of the outer thread 11′ of the screw 10′ and the inner thread 21′ of the nut 20′. The axis of the rollers 30 is parallel to the axes of the screw 10′ and nut 20′.

By modifying the thread profiles of the screw 10′ and nut 20′ as shown in FIGS. 4 and 6, the maximal Hertz contact pressure in the improved embodiment shown in FIG. 4 is directly reduced, while the two threads (e.g. the convex roller 30 thread profile with the concave screw 10′ thread profile and the convex roller 30 thread profile with the concave nut 20′ thread profile) have enveloping forms as shown in FIG. 4.

More specifically, the example shown in FIG. 4 can be described as having a roller 30 with a profile with at least a portion 33 extending between a trough 35 and a peak 36 that has a convex ogive radius 39 (as shown in FIGS. 3 and 5).

In the improved planetary roller screws, as shown in FIGS. 4 and 6 the modified screw 10′ and nut 20′ have at least a portion 13′, 23′ of their thread profiles that have a concave ogive radius 19′. In some examples, the screw 10 and nut 20 concave ogive radius/radii 19′ may also be twice the size of the corresponding roller convex ogive 39′ radius. This results in a maximal Hertz contact pressure that in this case is 20% less than in known systems. Since the life duration of a planetary Roller Screw is linked to the maximal Hertz contact stresses at the contact Roller/Screw and the maximal Hertz contact stresses at the contact Roller/Nut, such a reduction in pressure can therefore greatly improve the life duration of the roller screw.

In addition to this, in a situation wherein the space envelope of the Roller Screw is defined, reducing the Hertz contact stresses will also result in an increase in the static and dynamic load capacity of the Roller, which thereby increases the life duration of the roller screw.

In another situation wherein for a defined space envelope the life duration is satisfied, if the Hertz contact stresses are reduced, the space envelope of the Roller Screw will also be decreased, which will then result in the same static and dynamic load capacity being kept and so giving more space for the rest of the mechanism.

In a further situation, wherein the space envelope of the Roller Screw is defined, by reducing the Hertz contact stresses, the same static and dynamic load capacity of a Roller Screw can be kept by reducing the number of Rollers or by reducing the length of the Rollers.

The improved examples described herein therefore result in many advantages over known systems including: a higher life duration of the roller screw, less space envelope being required for the roller screw; less rollers being required to place in the roller screw; more space being given to the guiding bearings; more space being given to the electrical motor; a lower space envelope of the actuator integrating the roller screw and so easier installation in a thin wing of a fixed wing aircraft.

1. A planetary roller screw mechanism comprising:
a screw comprising an outer circumference with an outer thread disposed thereon;
a nut comprising an inner circumference with an inner thread disposed thereon, said nut being disposed around and positioned coaxially with the screw; and
a plurality of rollers disposed around the outer circumference of the screw, between the screw and the nut;
each of said rollers having an outer circumference with an outer thread disposed thereon, said roller thread engaging with said screw thread and said nut thread; and
wherein each of said plurality of rollers has a V-shaped thread profile that has at least a portion that is convex extending between a trough and an adjacent peak of the roller thread profile; and
wherein either one or both, of said screw and said nut has/have a V-shaped thread profile that has at least a portion that is concave extending between a peak and an adjacent trough of the screw or nut profile.

2. The mechanism of claim 1, wherein said convex portion of the roller thread profile of said plurality of rollers is aligned with said concave portion of the screw and/or nut thread profile.

3. The mechanism of claim 1,
wherein said convex portion of the roller thread profile has a convex ogive radius; and
wherein said concave portion of the screw thread profile and/or the nut thread profile has a concave ogive radius.

4. The mechanism of claim 3, wherein said screw and nut concave ogive radii are twice the size of the roller convex ogive radius.

5. A method of forming a planetary roller screw mechanism comprising:
providing a screw having an outer circumference with an outer thread disposed thereon;
positioning a nut around the screw so that the nut is coaxial with the screw, the nut comprising an inner thread; and
positioning a plurality of rollers around the other circumference of the screw, between the screw and the nut;
each of said rollers being provided with an outer thread aligned with the thread of the screw and the thread of the nut; and
wherein each of said plurality of rollers has a V-shaped thread profile that has at least a portion that is convex extending between a trough and an adjacent peak of the roller thread profile; and
wherein either one or both, of said screw and said nut has/have a V-shaped thread profile that has at least a portion that is concave extending between a peak and an adjacent trough of the screw or nut profile.

6. The method of claim 5, further comprising positioning said roller relative to said screw and said nut so that said convex portion of the roller thread profile aligns with said concave portion of the screw and/or nut thread profile.

7. The method of claim 5, wherein:
said roller thread profile has a convex ogive radius;
said screw thread profile has a concave ogive radius; or
said nut thread profile has a concave ogive radius.

8. The method of claim 7, wherein at least one of said screw or nut concave ogive radii are twice the size of the roller convex ogive radius.
